(19) United States
(12) Patent Application Publication
(10) Pub. No.: US 2026/0334723 A1
(43) Pub. Date: Oct. 29, 2026

(54) SELF-HEATING CONTAINER FOR FOOD PRODUCTS

(71) Applicants: Stefano MONTELLANICO, Roma (RM) (IT); Gabriele TEOFILATTO, Roma (RM) (IT)

(72) Inventors: Stefano MONTELLANICO, Roma (RM) (IT); Gabriele TEOFILATTO, Roma (RM) (IT)

(21) Appl. No.: 19/109,941

(22) PCT Filed: Sep. 6, 2023
(86) PCT No.: PCT/IB2023/058801

§ 371 Date: Mar. 7, 2025

(30) Foreign Application Priority Data
Sep. 7, 2022 (IT) 102022000018234

(51) Int. Cl. A47J 36/28; B65D 81/34; C09K 5/16

(52) U.S. Cl. CPC A47J 36/28; B65D 81/34; C09K 5/16

(57) ABSTRACT

Self-heating container for food products consisting of an external container (100), an inner container (200) and a cover (300) made of composite material with different layers comprising MYLAR-type polyester films, EPS-type polystyrene sheets and aluminum foils, wherein said external container (100) internally houses said inner container (200) and represents the heat engine of the system by means of the exothermic reaction generated by the hydration of the zeolite contained in a compartment (150) obtained in the lateral faces (190), in which said inner container (200) contains a eutectic mixture of citric acid and beta-alanine in a sealed compartment (250) obtained in the lateral faces (290) and wherein said cover (300) is connected to said external container (100) by means of a closure system (400) so as to create a hermetic seal of the inner container (200) in the constrained state.

### TECHNICAL FIELD

The present patent application for invention refers in general to the technical field of items for daily use and in particular to that of self-heating food containers.

The invention is applicable to any field, where such a type of invention can be advantageously used, but preferably this relates to the field of disposable tableware.

### Background Art

In contemporary society, governed by the constant increase in mobility and consumption, there is a growing demand for convenient and effective containers which can be used by consumers to heat products such as coffee, tea, milk, soups and many other types of drinks or food products, at any time and in any place, without having access to some conventional heating means such as a coffee maker, a microwave oven, a stove, an electric oven, etc. As is known, however, self-heating containers for food exist in the art, in which the heat supply is ensured extemporaneously by chemical substances contained in at least a gap of the container itself and which are capable of producing an exothermic reaction at a controlled speed. Typically, two or more reagents are initially separated by an unbreakable partition in the container and when heat must be generated, the partition is broken to allow the reagents to mix, thus creating an exothermic reaction for heat generation. Typically, the reactants employed to generate heat include at least a solid material, typically calcium oxide, and a liquid material such as water, the reaction of which forms calcium hydroxide.

However, the background art regarding self-heating food containers has many shortcomings. In particular, the formation of calcium hydroxide, if on the one hand makes the exothermic reaction particularly effective, on the other hand presents a whole series of drawbacks, which make the embodiments particularly disadvantageous.

The first drawback which can be highlighted in the background art consists in carrying out a highly exothermic reaction created by the hydration of calcium chloride. Many technical documents tend to minimize this drawback by using poorly conductive materials, capable on the one hand of prolonging and stabilizing the heat produced and on the other of preventing the users' hands from burning.

Another drawback lies in the fact that the production, use and disposal of current double-compartment self-heating containers with calcium oxide and water therein is highly polluting for the environment. Firstly, the production of calcium oxide is a process which requires a lot of energy and is thus not very environmentally friendly with current energy needs. Secondly, a further disadvantage instead lies in the fact that the self-heating containers conceived in this manner are difficult to recover and difficult to dispose of, precisely due to their intrinsic conformation and the content of calcium hydroxide therein, which makes the product exclusively disposable in a hazardous waste disposal center.

Another disadvantage lies in the fact that said containers require particular caution during storage, as following pressures on the surfaces, these containers could activate involuntarily or even break and release the dangerous calcium chloride content into the environment. In fact, it must be specified that, as is known to those skilled in the art, calcium hydroxide and, especially, calcium oxide are compounds having a significant chemical risk which can be manifested by handling, as they cause eye damage, skin irritation, strong irritation of the respiratory tract in the event of inhalation and the production of flammable and explosive gases.

A further drawback consists in the fact that said self-heating containers, precisely because of the chemical risk associated with the reagents contained, are limited for use in many environments such as, for example, on aircraft and which, as is easily understandable, would represent the ideal places where such a type of product would be advantageously used.

In light of the above, it is clear and evident that the background art has undisputed technical problems and that, therefore, there is a strong need to resolve them.

Therefore, an unavoidable need still exists to advance the state of the art by making a self-heating container for food products, designed to solve or at least minimize the above problems, as will appear from the detailed description of one of its forms of exemplary and non-limiting execution, illustrated below.

### SUMMARY OF THE INVENTION

With the present patent application for an industrial invention, it is intended to describe and claim a process provided with at least a new and alternative solution to the solutions known so far and in particular the aim is to overcome one or more of the drawbacks or problems referred to above and/or to satisfy one or more needs perceived in the art and in particular deduced from what has been reported above. For this purpose, the inventors have developed a self-heating container for food products consisting of two containers which can be stacked and fit into each other and by a relative cover.

More specifically, said first container comprises the heat engine of the creation while the second container which can be fitted into the first consists of structured walls, so as to effectively modulate the heat produced by the first container and to contain the food product intended to be heated.

The innovative concept underlying the present invention consists in envisaging that both said containers can be reused multiple times, carrying out a simple regeneration in an electric oven for the first container and a common effective dish-washing for the second container.

The first container contains, in a gap made in the walls, a dehydrated and easily available substance, intended to be activated with water, which can be added using a common syringe when needed. Instead, in a sealed gap, made in the walls of the second container, there is a eutectic fluid providing a series of thermal kinetic benefits, as reported below.

From this brief description, some benefits of the present invention appear evident, among which emerges that deriving from the fact that the inventive product is perfectly eco-compatible, considering the possibility of reusing the materials used, associated both with the low costs of the chemical reagents used and with the ease of disposal thereof.

As will also be reported below in the experimental section of the present invention, the inventors have carried out a very detailed examination of the feasibility of the project as a function of the numerous variables involved, from which a series of advantageous chemical substances, easily acquired and free of chemical risk has been identified.

More specifically, it was discovered that an excellent chemical reagent, adapted to be contained in the gap of the first container, capable of reacting with water and thus producing a balanced exothermic chemical reaction, is represented by zeolite, which is a natural or synthetic chemical without any chemical risk, so much so that it can also be used as a low-cost food supplement.

Another particularly advantageous feature is that of using a eutectic fluid contained in the gap of the second container, capable of optimizing the thermal performance carried out by the zeolite, as said eutectic fluid is endowed with interesting characteristics in terms of thermal conductivity and thermal capacity. Said eutectic fluid consists of water and a mixture consisting of equimolar quantities of citric acid and beta-alanine which, as is known, represent constituents of the human diet and are therefore chemical substances totally free from chemical risks of any kind.

In light of what has just been stated, it is understood how this solution according to the present invention forms an optimal compromise, as on the one hand it uses substances free of any chemical risk and on the other low-cost and perfectly eco-compatible substances; therefore, overall it is considered an inventive product having a whole series of advantages with respect to those present in the background art. In particular, the use of said inventive product is totally free of chemical risks and can thus be carried out even in those places where common products cannot be used, consider aircraft where the known products were particularly disadvantageous due to the associated chemical risks. Another favorable characteristic lies in the fact that the inventive product is totally eco-compatible and has a low production cost, on the one hand due to the possibility of being reused and on the other on the basis of the type of chemical substances used.

A further objective is to propose a self-heating container for food products, which can be manufactured on an industrial scale and whose components are of a standard type and perfectly available on the market.

As regards the dimensions of said inventive self-heating container for food products, it should be noted that these are purely indicative and not restrictive of the invention, however, the dimensions can be expressed and overall summarized as regards the external dimensions in a range between 138 mm×115 mm×43 mm and 168 mm×141 mm×53 mm and more preferably equal to 53 mm×128 mm×48 mm and as regards the internal capacity in a range between 405 cm² and 495 cm² and more preferably equal to 450 cm².

Other characteristics of the present invention will be described in the following detailed description of one or more specific embodiments, protected by the various dependent claims.

### BRIEF DESCRIPTION OF THE DRAWINGS

The previous advantages, as well as other advantages and characteristics of the present invention, will be illustrated by referring to the attached figures, which are to be considered purely illustrative and not limiting or binding for the purposes of the present patent application, in which:

FIG. 1 is a top perspective view of the components of the inventive self-heating container;

FIG. 2 is a bottom perspective view of the components of the inventive self-heating container;

FIG. 3 is a top perspective view sectioned from a front plane of the components of the inventive self-heating container;

FIG. 4 shows the graph showing the thermal conductivity of the zeolite at 50 °C (A) and 100 °C (B);

FIG. 5 shows the graph showing the thermal kinetics of the zeolite;

FIG. 6A-B show the graphs showing the comparative kinetics of three different chemical systems;

FIG. 7A-B show the graphs showing the thermal conductivities of water and eutectic fluid;

FIG. 8 shows the graph showing the thermal kinetics detected in the pre-cooked food at the maximum distance from the walls of the prototype container with and without eutectic;

FIG. 9 shows the graph showing the thermal kinetics detected in the pre-cooked food near the walls of the prototype container with and without eutectic.

### DETAILED DESCRIPTION OF THE INVENTION

The present invention will now be described in detail with reference to the figures and only to some of the possible embodiments, it being possible to describe many others on the basis of the particular technical solutions identified.

Referring to the different figures, these show a self-heating container for food products, which as shown in FIGS. 1-3, comprises an external container 100, an inner container 200 and a cover 300 consisting of composite material with different layers. In particular, said external container 100 forms the heat engine of the entire system, said inner container 200 forms on one hand the collector of food products and on the other, by means of the walls, creates a modulation of the thermal conductivity of the heat produced by the heat engine and lastly said cover 300 is connected to said external container 100 so as to create a hermetic seal of the same inner container 200 in the constrained state.

Said inner container 200, in turn, is adapted to fit inside the external container 100, so as to be stably coupled thereto and to be released only in the face of an external force directed vertically upwards.

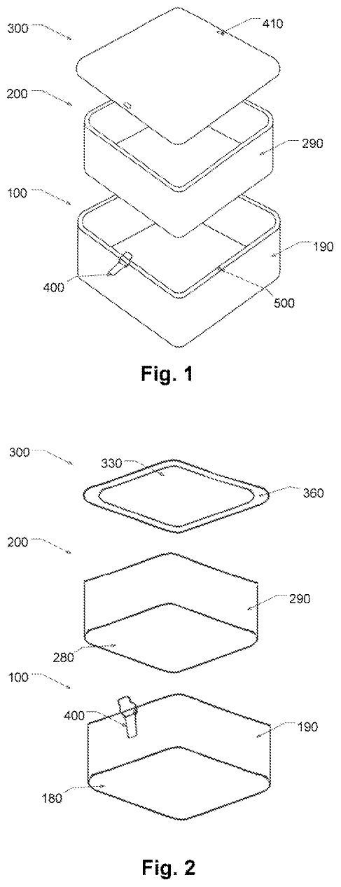

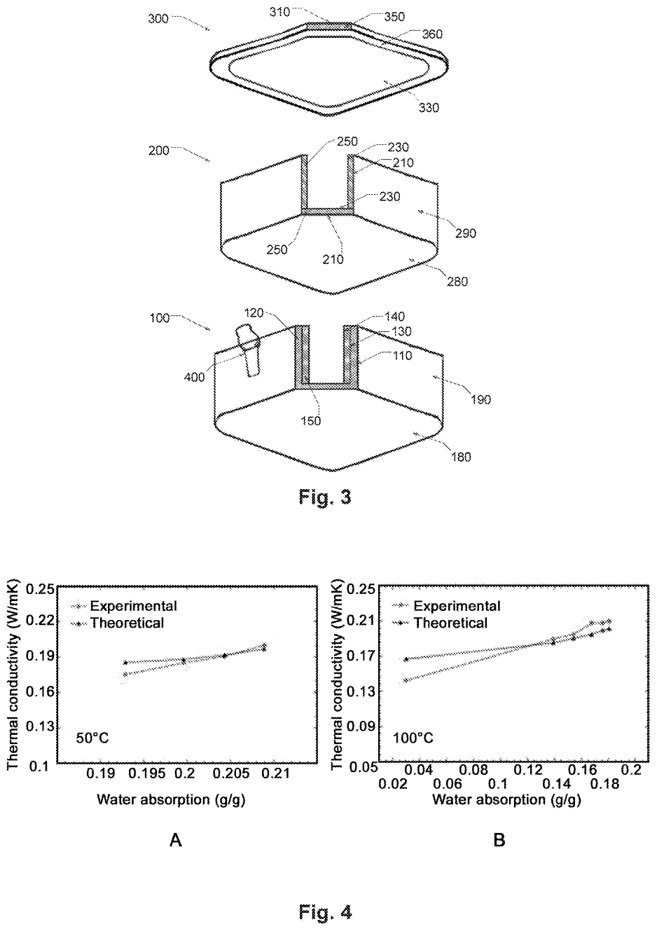

Going into more detail in FIGS. 1-3, said external container 100 has the shape of a rectangular parallelepiped consisting of an open upper base, a lower base 180 (FIG. 2) and by four lateral faces 190 forming the walls. Even more specifically, as depicted in FIG. 3, said lateral faces 190 and said lower base 180 are formed by an outer layer 110 comprising a polyester film, preferably of the MYLAR type, which offers great resistance to traction, tears and impacts. An insulating layer 120 adheres to said outer layer 110 of said lateral faces 190 and to said lower base 180, the insulating layer consisting of a polystyrene sheet, of the EPS type which, as is known, has insulating properties, allowing it to provide a barrier to the escape of heat and at the same time providing rigidity and lightness, which make it suitable for profitable application. The inner face of said insulating layer 120 is in turn covered by a layer 130 formed by aluminum foil adhered thereto. Referring only to the lateral faces 190, inside said layer 130 there is a further inner layer 140 formed by aluminum foil. The volume comprised between said layer 130 and said inner layer 140 forms a compartment 150, which is partially occupied by a chemical compound in the dehydrated state, capable of reacting with water and creating a highly exothermic reaction. Said chemical compound is zeolite which, as is known to those skilled in the art, has a peculiar reversible property of dehydration, giving rise to an endothermic process, and of re-hydration, giving rise to an exothermic process. As shown in FIG. 1, the quantity of water suitable for the exothermic hydration process is introduced into the compartment 150 by means of a common syringe, filled with the required quantity of water, through at least an orifice made above said compartment 150 and occupied by a vapor permeable valve 500. It is easy to understand how the advantageous concept of multiple reuse of said external container 100 can easily be achieved by subjecting the external container 100 to a dehydration cycle by means of heating in an electric oven, suitable for evaporating the water and letting the steam escape through said vapor permeable valve 500. Referring to the quantity of zeolite present in the compartment 150, it must be understood that the weight percentage of water with respect to said dehydrated zeolite is between 61% and 50% and more preferably equal to 56%. A particularly preferred embodiment of the present invention envisages that the granulometry of the zeolite has a grain size equal to 3 angstrom (Å).

Referring to FIGS. 1-3, said inner container 200 has the shape of a rectangular parallelepiped consisting of an open upper base, a lower base 280 and four lateral faces 290 forming the walls. Even more specifically, as depicted in FIG. 3, said lateral faces 290 and said lower base 280 consist of an outer layer 210 and an inner layer 230, in which both said layers are formed by aluminum foil. As regards only the lateral faces 290, the volume between said outer layer 210 and said inner layer 230 forms a sealed compartment 250, occupied by a eutectic fluid. A further preferred embodiment envisages that said eutectic fluid comprises a mixture consisting of equimolar quantities of citric acid and beta-alanine and 83.5% by weight of water with respect to the aforementioned mixture. Conversely, the volume between said outer layer 210 and said inner layer 230 of said lower base 280 forms an insulating compartment 260 which is occupied by a polystyrene (EPS) sheet.

As regards said cover 300, with particular reference to FIGS. 1-3, this has a quadrangular shape adapted to close the upper opening of the external container 100 with the inner container 200 fitted inside. As shown in FIG. 3, said cover 300 is formed by an insulating element 350 consisting of a polystyrene (EPS) sheet, whose upper face is covered by an outer layer 310 adhered thereto and formed by a polyester film, of the MYLAR type and in which an inner layer 330 formed by an aluminum foil is adhered to the lower face of said insulating element 350. The lower peripheral portion of said cover 300, as shown in FIGS. 2 and 3, lacks said inner layer 330 and forms the insulating portion 360, which terminates near the upper face of the aforementioned compartment 150, with which it enters in correspondence in the closed condition of the inventive self-heating container.

Although any closure system capable of constraining said cover 300 to the external container 100 with the inner container 200 fitted inside can be considered, in the illustrated example, in particular with reference to FIGS. 1-3, said closure system 400 consists of at least two clips positioned externally on at least a pair of opposite lateral faces 190 and so that said closure system 400 is adapted to engage and constrain two retaining means 410 in the closed condition (FIG. 1), placed above the outer layer 310 of said cover 300.

Further preferable characteristics according to the present invention relate to the fact that the aluminum foil and the MYLAR-type polyester film, both listed above, have a thickness preferably equal to 100 μm. A further characteristic relates to the fact that the EPS-type polystyrene sheets preferably have a thickness of 3 mm.

A further aspect, aside from all the technical solutions described so far, but of particular relevance in the embodiment of the invention, relating to the advantageous concept according to which said inventive self-heating container can be inventively reused multiple times, envisages a recovery process, operating a simple regeneration process for the external container 100 by dehydrating the zeolite in an electric oven at 200 °C for at least 2 hours and a common effective dish-washing for the inner container 200 and for the relative cover 300. Also paying attention to the chemical characteristics of all the chemical constituents of the reaction, which, as is known, have an irrelevant if not zero chemical risk, it is appropriate to underline that the present inventive device can also be used in sites where the existing containers in the background art cannot be used, as for example on aircraft where this specific implementation appears particularly advantageous.

To better define the optimal characteristics just mentioned in the present description and also for the purpose of selecting the chemical constituents, already represented in this description and which, as will be seen in the examples section, will be reported below, the inventors carried out in-depth studies and long experiments aimed at obtaining a desirable self-heating container for food products. More specifically, it should be noted in the first instance that it was necessary to carry out a chemical study linked to the usable substances and the respective thermal kinetics, taking into account the parameters of environmental sustainability, toxicological safety, chemical risk associated with storage, handling and accidental spills, as well as the thermal efficiency parameters, weights and volumes and the simplicity of separation of the chemical components so as to simplify the engineering of the tray as well as the cost and homogeneous distribution of the substances during the exothermic mixing step.

### Examples

The inventors of the present patent, as shown in detail in FIGS. 4-9, carried out a preliminary chemical study phase necessary to tackle the project, which involved the development of an advantageous self-heating plate for food products. What has been stated arises from the need that, only after an evaluation of different exothermic chemical systems, was it possible to address the chemical-physical simulation part necessary to obtain data which allow, in addition to the choice of the best chemistry, the feasibility study linked to the mechanical characteristics of the plate and the choice of materials.

### Energetic Motor: Formulations Analyzed

The following pages mention the thermodynamic data linked to the substances which can be used for the various exothermic systems, the quantitative ratios necessary for each system as well as their thermodynamic characteristics.

### Zeolite

Table 1 below shows the diffusivity and thermal conductivity of zeolite.

TABLE 1

| Thermal Diffusivity | | | Thermal Conductivity | | |
|---|---|---|---|---|---|
| Thermal | 0.21 | W/m-κ | Density (q) | 700 | Kg/m³ |
| Conductivity | | | | | |
| (κ) | | | | | |
| Density (q) | 700 | Kg/m³ | Specific Heat | 1200 | J/Kg-K |
| | | | Capacity (C_{ρ}) | | |
| Specific Heat | 1200 | J/Kg-K | Thermal | 0.00000025 | m²/s |
| Capacity (C_{ρ}) | | | Diffusivity (α) | | |
| Calculation for | α = K/ρ_{Cρ} | | Calculation for | K = αρc_{ρ} | |
| Thermal | | | Thermal | | |
| Diffusivity | | | Conductivity | | |

K = 0.21 W/m*K

Thermal diffusivity: α=2,500e−7 m²/s=0.25 mm²/s
Thermal conductivity: k=0.21 W/m*K

The thermal conductivity of dehydrated zeolite is 1.2 W/m K, while wet is 0.21 W/m K.

### Summarizing:

Density=700 Kg/m³
Specific thermal capacity=1200 J/Kg K
Thermal Conductivity=0.21 W/m*K
Thermal diffusivity=0.25 mm²/s

As regards the hydration heat generated, it is equal to 200 J/g.

Considering that we will use 28.34 g of zeolite, 5668 J (5,668 KJ) can be generated. As mentioned previously, the thermal conductivity of zeolite varies as a function of the water absorbed and the temperature. The data shown in FIGS. 4A-B, show this aspect in more detail. Furthermore, we can note the possible deviation between theoretical and experimental.

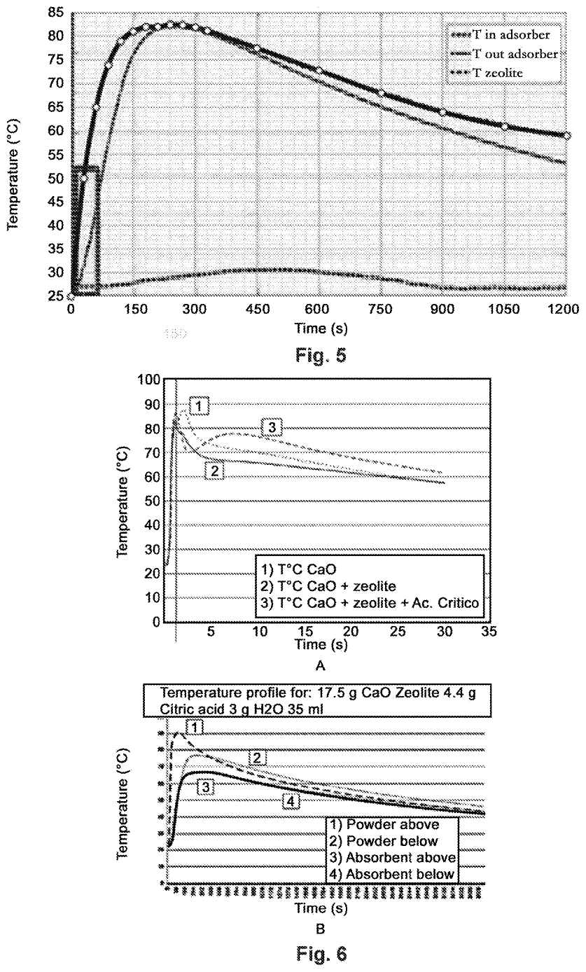

Another useful aspect consists in highlighting the thermal kinetics of zeolite. In FIG. 5 we can see the evolution of the TC as a function of time (t) in the exothermic process due to the hydration heat.

Given the need to introduce the volumes necessary for the simulation, we can consider that the average zeolite grain size of 3 Å (KLTA) is 1.58 mm.

Considering that the granules have an average density of 0.7-0.8 g/ml and that 28.34 g of zeolite will be used, this means a volume which can fluctuate between 35.42 cm³ and 40.48 cm³. Furthermore, the water that must be absorbed by the zeolite has a volume equal to 16 cm³. A total volume between 52 cm³ and 57 cm³ can be deduced.

The synthetic zeolite used has such characteristics, as it has a porosity of 3 angstrom, contains the cation K, has a Si/Al ratio of 1 and is previously dehydrated at 500 °C. Such zeolite, in the quantities envisaged, i.e.:

28.34 g of zeolite+16 g H₂O is capable of causing a Delta TC equal to 69 °C, that is, if starting from a temperature of 15 °C, 84 °C can be reached following the hydration heat.

The data is to be considered experimental data and not merely theoretical.

### Calcium Oxide (CaO) and CaO+Zeolite

We start by considering the stoichiometric equation for the reaction between calcium oxide and water:

CaO+H₂O→Ca(OH) 2
they react in a 1:1 ratio. Thus, 1 mole of calcium oxide reacts with 1 mole of water. Since the reaction heat is equal to ΔH=−95.3 KJ/mol and considering that with the quantities used:

CaO=17.5 g+35 ml H₂O,
an increase in temperature delta TC=65 °C is obtained (measurement through calorimeter). The energy absorbed by water is equal to:

E=m×c×ΔT=35 g×4.19 J/g °C×65 °C=272.35 J o 0.272 kJ (rounded to three digits).
E=enthalpy
   c=specific thermal capacity of water (4.19 J/g °C)
   m=mass of heated water
   ΔT=water temperature variation (°C)

Since this was due to 17.5 g of CaO, which has a molar mass of 56.1 g, the number of moles of CaO used is:

17.5 g/56.1 g/mol=0.311 mol

Therefore, the reaction heat E is equal to:

0.272 KJ÷0.311 Mol=0.874 KJ/mol
or more correctly, −0.874 KJ/mol since the reaction is exothermic.

In FIGS. 6A-B, however, the comparative thermal kinetics between
1) CaO (100%)
2) CaO+zeolite mixture (84% CaO 16% H₂O)
3) CaO+zeolite+citric acid mixture (77% CaO, 14% zeolite and 9% citric acid)

Show the evolution of the T °C as a function of time (t) in the exothermic process due to the hydration heat

### Eutectic Fluid—Thermodynamic Advantages

In the following pages, the most relevant advantages for the use of the inventive eutectic fluid in the gap of a prototype container are highlighted.

### Thermodynamic Values for Equimolar Eutectic Mix of Citric Acid/Beta-Alanine

The calculation of the thermal capacity (Cp) of the eutectic fluid based on water, citric acid and beta-alanine is carried out using the relationship

$$Cp mixture - ( \frac{m 1}{m mixture} ) \text{?} Cp 1 + ( \frac{m 2}{m mixture} ) \text{?} Cpn + ( \frac{m n}{m mixture} ) \text{?} Cpn$$

$$\text{?} \text{indicates text missing or illegible when filed}$$

Where:
Cp=thermal capacity
m=mass of the fluid is m1+m2

The calculation of the thermal capacity Cp of the eutectic fluid provides the following results:

Cp=1144.58 J/kg·K
Total mass: 299.23 g
Number of materials: 2
1) Citric acid:
   Mass in g: 210.14
   Fluid percentage: 70.23%
   Specific thermal capacity: 1075.92 J/kg·K
2) Beta Alanine:
   Mass in g: 89.09
   Fluid percentage: 29.77%
   Specific thermal capacity: 1306.54 J/kg·K

Therefore, with a thermal capacity (Cp)=1253.33 J/kg·K and a density (ρ)=1300 Kg/m³, Table 2 is shown below, reporting the diffusivity and thermal conductivity of the eutectic fluid.

TABLE 2

| Thermal Diffusivity | | | Thermal Conductivity | | |
|---|---|---|---|---|---|
| Thermal | 0.484 | W/m-κ | Density (q) | 1300 | Kg/m³ |
| Conductivity | | | | | |
| (κ) | | | | | |
| Density (q) | 1300 | Kg/m³ | Specific | 1253.33 | J/Kg-K |
| | | | Heat | | |
| | | | Capacity | | |
| | | | (C_{ρ}) | | |
| Specific | 1253.33 | J/Kg-K | Thermal | 0.0000002971 | m²/s |
| Heat | | | Diffusivity | | |
| Capacity | | | (α) | | |
| (C_{ρ}) | | | | | |
| Calculation | α = K/ρ_{Cρ} | | Calculation | K = αρc_{ρ} | |
| for Thermal | | | for Thermal | | |
| Diffusivity | | | Conductivity | | |

K = 0.21 W/m*K

### Calculation:

Thermal diffusivity: α=2.971e−7 m²/s=0.297 mm²/s
Thermal conductivity: k=0,484 W/m*K

In Table 3 below, considering a polyester fiber which can be used and is heat-resistant and impervious to gas and humidity, such as Mylar (either as an elastic or rigid membrane), the penetration depth is calculated.

TABLE 3
PENETRATION DEPTH

| Thermal Diffusivity (α) | 0.297 (mm²/s) | |
|---|---|---|
| Time (t) | 0.5 | sec |
| Sample thickness | 1 | mm |

| | |
|---|---|
| Calculation for Thermal | D = k\sqrt{at} |
| Diffusivity | |

### Calculation:

penetration depth (D)=0.77 mm
sample penetration depth %=77.07%

It thus appears to have a degree of thermal penetration equal to 77.07%.

### Comparison of the Thermal Conductivity Between Water and Eutectic Fluid

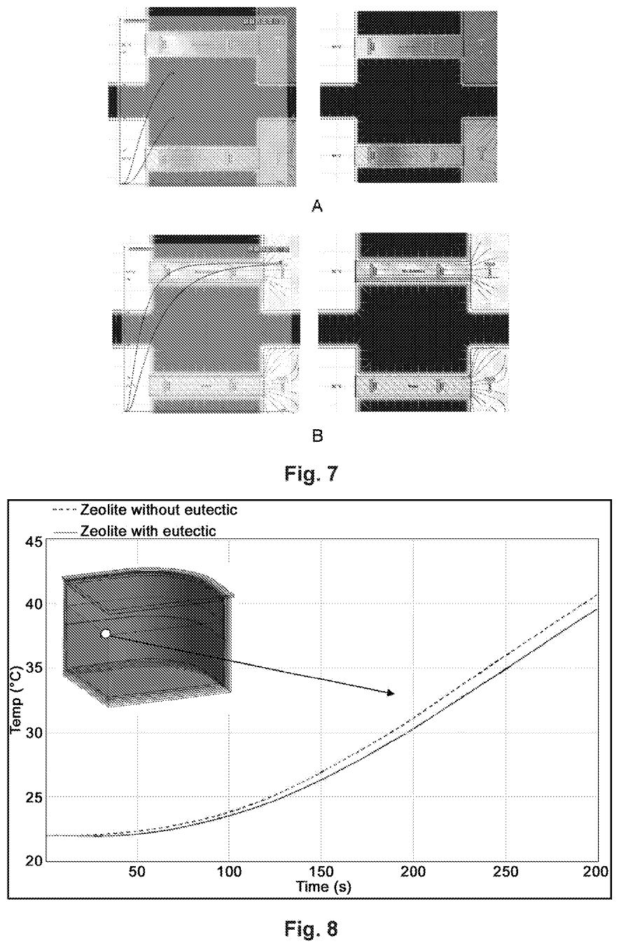

Below, as shown in FIGS. 7A-B, a comparison was carried out on the thermal conductivity of water (T2) and eutectic fluid (T1) with the source temperature set at 90 °C.

As shown in the graph in FIG. 7A, at 2.4 sec the body reaches a temperature of 38.9 °C for the water (T2) and a temperature of 68.5 °C for the eutectic fluid (T1). As shown in the graph in FIG. 7B, at time 13.6 sec for water and at time 8 sec for eutectic 1, the body reaches the temperature of 89.2 °C.

Thus the eutectic fluid is shown to be a 40 to 50% better conductor of water.

### Results Obtained in Simulations Carried Out in a Laboratory Suitable for the Thermodynamic Study of the Thermo-Fluid Dynamic Distribution of a Prototype Self-Heating Tray.

The different behavior of two models was analyzed, in which one is with the eutectic fluid and the other is without it, on a prototype model shown in FIG. 7.

The quantity of food (dry pasta) used was equal to 150 g and the pasta T0=18.8 °C.

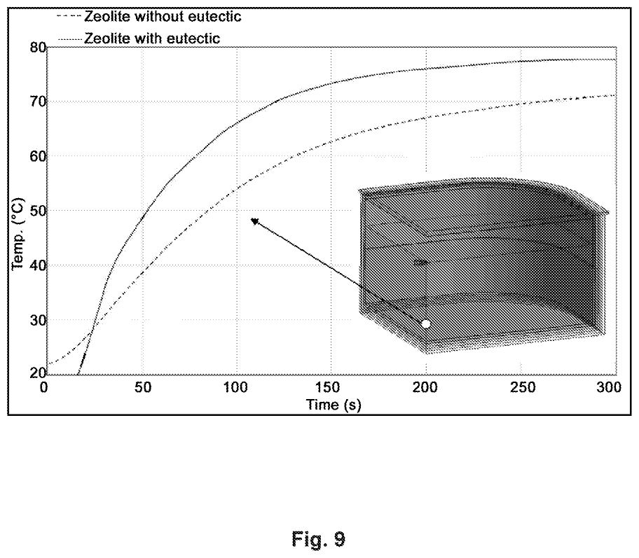

By analyzing the results and the dynamics developed, we can summarize the results briefly in FIGS. 8 and 9.

FIG. 8 shows a dynamic analysis of the temperature in the center of the pre-cooked food at the maximum distance from the walls. We can see how in the center of the food, at the point farthest from the walls, the increase in TC in the two systems, with or without the gap where the eutectic fluid is contained, does not show any particular significant differences at the end of 300 sec (5 min), all reaching a temperature range between 38 °C and 41 °C.

FIG. 9 shows a dynamic analysis of the temperature in the center of the pre-cooked food at a distance close to the walls. In this case, the gap with the eutectic fluid shows its effectiveness by showing an interesting characteristic, that is, that the thermal conductivity increases with increasing temperature following the change in viscosity to which it is related. This intrinsic phenomenon is favorable, as it shows an ability to accumulate heat in the early stages and later (given its electrical conductivity) to deliver it to the system. In fact, we can see how in the first phase the temperature of the food in the center is lower (0-130 sec) but subsequently the systems with the eutectic fluid show an increase in temperature while the systems without eutectic fluid decrease (130-300 sec).

Below are the qualitative and quantitative values of the constituents of the system consisting of the zeolite+H₂O formulation and object of the experimentation:

29.84 g of 3 Å zeolite+17.5 g of H₂O=total weight=47.34 g

With the model which envisages a gap in which the eutectic fluid is present, said fluid consists of the eutectic mixture formulation:
formula 1/1 molar----210.14 g of citric acid 89.09 g of beta-alanine=total weight=300 gr

To formulate the fluid to be introduced into the gap, the following are used:
21 g of eutectic and 17.5 g of H₂O are added
   obtaining: 38.5 g of 40% eutectic.

### CONCLUSIONS

The characteristics which emerge from such an experiment obtained using the system with zeolite and eutectic fluid reported above are:
low weight of reaction chemicals 47.34 g;
good thermal efficiency and a good ratio between thermal conductivity and thermal storage;
the exothermic reaction due to substances such as zeolite (granular) is non-toxic, recyclable and environmentally friendly;
water is added without the addition of acids or bases.

It also involves respect of the envisaged terms for:
environmental sustainability;
toxicological safety;
risk of storage, handling, accidental spills, etc.

Additional parameters detected:
thermal efficiency;
weights and volumes (with the condition of obtaining the lowest possible weight and volume);
simplicity of separation of the chemical components (before the reaction) so as to simplify the engineering of the tray as well as the cost and homogeneous distribution of the substances during the mixing step (exothermic reaction step).

Furthermore, the use of the eutectic mixture as a fluid present in the gap allows an innovative use for self-heating tray systems as:
It increases thermal efficiency, making it possible to eliminate the formation of other exothermic reactions with the use of calcium oxides (CaO) or other less sustainable compounds from the perspective of risk and ecological sustainability and which create reaction by-products both in the aqueous phase and in gaseous phase which are less sustainable from the point of view of risk and ecological sustainability.

Obviously the data provided here are purely illustrative and absolutely not limiting the scope of the present invention, as they rather serve to extend and not limit the content of the present invention. Several obvious modifications could clearly be made by the average person skilled in the art to the previous exemplary and non-limiting embodiments described with reference to the figure, without this implying an extension beyond the inventive concept, which is the basis of the present invention, as defined by the following dependent claims.

Translation of the Drawings

| FIG. 4 | FIG. 4 |
|---|---|
| Sperimentale | Experimental |
| Teorico | Theoretical |
| Conducibilità termica | Thermal conductivity |
| Assorbimento acqua | Water absorption |
| FIG. 5 | FIG. 5 |
| Temperatura | Temperature |
| Tempo | Time |
| FIG. 6 | FIG. 6 |
| Temperatura | Temperature |
| Tempo | Time |
| Mix CaO + zeolite | Mix CaO + zeolite |
| Mix CaO + zeolite + Ac. citrico | Mix CaO + zeolite + Citric acid |
| Profilo temperatura per: 17.5 g | Temperature profile for: 17.5 g |
| CaO Zeolite 4.4 g Ac. Citrico 3 g | CaO Zeolite 4.4 g Citric acid 3 g |
| H2O 35 ml | H2O 35 ml |
| Sopra la polvere | Powder above |
| Sotto la polvere | Powder below |
| Sopra l'assorbente | Absorbent above |
| Sotto l'assorbente | Absorbent below |
| FIG. 8-FIG. 9 | FIG. 8-FIG. 9 |
| Zeolite senza eutettica | Zeolite without eutectic |
| Zeolite con eutettica | Zeolite with eutectic |
| Temp. | Temp. |
| Tempo | Time |

1. Self-heating food container formed by an external container (100), an inner container (200) and a cover (300), characterized in that said external container (100), said inner container (200) and said cover (300) are formed of composite materials including different layers, and in that said inner container (200) is adapted for engaging within the external container (100), so as to be stably coupled thereto and to disengage therefrom only when a vertically acting external force is applied, and in that said cover (300) is connected with said external container (100) in such a way as to seal the inner container (200), in the engaged condition, and in that zeolite is received inside a compartment (150) obtained in the walls of said external container (100), and in that inside a sealed compartment (250) obtained in the walls of said inner container (200) there is an eutectic fluid.

2. Self-heating container according to claim 1, in which said external container (100) has a shape of a rectangular parallelepiped comprising an open upper base, a lower base (180) and four lateral faces (190) forming the walls and is characterized in that said lateral faces (190) and said lower base (180) are formed of an outer layer (110) including a polyester film, and in that an insulating layer (120) formed of a polystyrene sheet adheres to an inner side of said outer layer (110), and in that a layer (130) of aluminum foil adheres to an inner face of said insulating layer (120), and in that said lateral faces (190) include on the inner side of said layer (130) a further inner layer (140) made of aluminum foil, and in that a volume enclosed between said layer (130) and said inner layer (140) forms said compartment (150), and in that on the upper part of said compartment (150) at least an orifice is obtained in which a vapor permeable valve (500) is arranged, which is adapted for allowing the introduction of water therein, using a common syringe.

3. Self-heating container according to claim 1, in which said inner container (200) has a shape of a rectangular parallelepiped comprising an open upper base, a lower base (280) and four lateral faces (290) forming the walls and is characterized in that said lateral faces (290) and said lower base (280) are formed of an outer layer (210) and an inner layer (230) formed of aluminum foil, and in that a volume enclosed between said outer layer (210) and said inner layer (230) of said lateral faces (290) defines said sealed compartment (250), and in that a volume enclosed between said outer layer (210) and said inner layer (230) of said lower base (280) defines an insulating compartment (260) occupied by a polystyrene sheet.

4. Self-heating container according to claim 1, in which said cover (300) has a quadrangular shape adapted for closing the open upper base of the external container (100) and of the inner container (200) engaged in its interior and characterized in that said cover (300) is formed of an insulating element (350) consisting of a polystyrene sheet, and in that an outer layer (310) formed by a polyester film adheres to an upper face of said insulating element (350), and in that an inner layer (330) of aluminum foil adheres to a lower face of said insulating element (350), and in that a lower peripheral portion of said insulating element (350) forms a resulting insulating portion (360) devoid of said inner layer (330), and in that said insulating portion (360) terminates close to an upper face of said compartment (150), towards which it faces in a closed condition.

5. Self-heating container according to claim 1, characterized in that said eutectic fluid contained within said sealed compartment (250) comprises a mixture consisting of water, citric acid and beta-alanine, and in that said eutectic fluid is formed by equimolar quantities of citric acid and beta-alanine and by 83.5% by weight of water in the mixture.

6. Self-heating container according to claim 1, characterized in that the water percentage with respect to the zeolite in a dehydrated state, contained in said compartment (150), is between 61% and 50% and more preferably it equals 56%, and in that the zeolite granulometry has a grain size equal to 3 angstrom (Å).

7. Self-heating container according to claim 1, characterized in that said polystyrene sheet is formed of sintered expanded polystyrene and in that said polystyrene sheet has a thickness of 3 mm.

8. Self-heating container according to claim 1, characterized in that said polystyrene film is of the MYLAR kind and in that said polystyrene film and said aluminum foils have a thickness of 100 μm.

9. Self-heating container according to claim 1, characterized in that a closure system (400) links the cover (300) to the external container (100), and in that said closure system (400) is formed by at least two clips arranged externally on at least a pair of opposite lateral faces (190), and in that said clips are adapted to engage, in the closed condition, respective retaining means (410) located on the upper part of said cover (300).

10. Self-heating container according to claim 1, characterized in that the sizes of the external container (100) are within an interval between 138 mm×115 mm×43 mm and 168 mm×141 mm×53 mm and preferably are equal to 53 mm×128 mm×48 mm, and in that the internal capacity of said inner container (200) lies in an interval between 405 cm² and 495 cm² and preferably it equals 450 cm².

11. A process for allowing a reuse of the self-heating container according to claim 1, characterized in that said external container (100) is adapted to undergo a regeneration process under dehydration of the zeolite, and in that said regeneration process occurs in an electric furnace at 200 °C for at least 2 hours, and in that said inner container (200) and cover (300) are adapted to undergo a common dish washing.
